(19) United States
(12) Patent Application Publication
(10) Pub. No.: US 2023/0317346 A1
(43) Pub. Date: Oct. 5, 2023

(54) TIE PLATE FOR A TRANSFORMER CORE ASSEMBLY

(71) Applicant: HITACHI ENERGY SWITZERLAND AG, Baden (CH)

(72) Inventor: Dietrich Bonmann, Meckenheim (DE)

(21) Appl. No.: 18/022,191

(22) PCT Filed: Oct. 12, 2021
(86) PCT No.: PCT/EP2021/078101

§ 371 Date: Feb. 20, 2023

(30) Foreign Application Priority Data
Nov. 30, 2020 (EP) 20210766.0

(51) Int. Cl. H01F 27/26

(52) U.S. Cl. CPC H01F 27/263

(57) ABSTRACT

A transformer core assembly is provided that comprises a first yoke clamping plate for clamping a first yoke of a transformer core, and a second yoke clamping plate for clamping a second yoke of the transformer core. Further, the transformer core assembly comprises a plurality of stacked sheets forming a tie plate. The tie plate has a first end and a second end, wherein the first end is connected to the first yoke clamping plate and the second end is connected to the second yoke clamping plate. Using stacked sheets for forming the tie plate significantly improves the availability of a suited material for manufacturing the tie plate. For example, there is a class of high manganese steel material having an adequate, high tensile strength.

### CROSS REFERENCE TO RELATED APPLICATIONS

This application is a 35 U.S.C. § 371 national stage application of PCT International Application No. PCT/EP2021/078101 filed on Oct. 12, 2021, which in turn claims priority to European Patent Application No. 21210766.0, filed on Nov. 30, 2020, the disclosures and content of which are incorporated by reference herein in their entireties.

### TECHNICAL FIELD

The present disclosure relates to a transformer core assembly comprising a tie plate and to a tie plate for use with a transformer core assembly.

### BACKGROUND

A transformer is a passive electrical device that transfers electrical energy from one electrical circuit to another, or to multiple circuits. A typical transformer comprises a ferromagnetic core having several, e.g., three parallel limbs, which are often oriented vertically, extending between a first or bottom yoke and a second or top yoke. Coils or windings are wounded around the limbs. A varying current in any one of the windings produces a varying magnetic flux in the core, which induces a varying electromotive force across any other winding wound around the core.

Typically, the core is a laminated construction made from a plurality of stacked core sheets. The transformer further comprises two first or bottom yoke clamping plates for clamping the core sheets within a section of the core forming the bottom yoke, from two opposite sides, and two second or top yoke clamping plates for clamping the core sheets within a section of the core forming the top yoke.

Further, the transformer comprises an elongate tie plate positioned next to and parallel to a limb. The tie plate is fixed, usually via a welding connection, with one end to one of the bottom yoke clamping plates and with its other end to one of the top yoke clamping plates.

The tie plate generally has one or more of the following functions:
Bear axial forces, i.e., forces parallel to the extension of the limbs, caused by the weight of the core and the windings when the transformer assembly is lifted, e.g., by a crane for transportation of the transformer assembly. A hook of the crane is usually connected to the top yoke clamping plates.
The windings must be maintained securely compressed axially for the life of the of the transformer assembly. To this end press rings are mounted at the top and the bottom of the winding block. These press rings rest against the top clamping plates and the bottom clamping plates, respectively. The reaction force of the winding compression force must be taken by the tie plate.
During electrical short circuits in a network, very high pulsating electromagnetic forces are generated in the windings which tend to compress the winding further. The above-mentioned pre-compression effectuated by the press rings generated at the time of the assembly shall ensure that the upper and lower winding ends keep contact to the press rings. Such forces have to be taken by the tie plate as well.

A tie plate generally shall consume a minimum of the available cross section inside the winding. Therefore, the tie plate is usually made from high strength, magnetic steel. This kind of material is comparatively cheap and shows an appropriate strength. However, more and more frequently, transformers are exposed to non-alternating currents, i.e., direct currents, e.g., by an increasing use of power electronics which may cause a direct current bias magnetization which in turn causes saturation of the magnetic transformer core. Excess magnetic flux is thereby pushed into the magnetic tie plate where it causes excessive eddy current heating. This particularly reduces effectiveness of the transformer assembly and additionally requires increased cooling.

Simply using a non-magnetic steel instead of magnetic steel for manufacturing a tie plate is disadvantageous insofar as most of the non-magnetic steels have merely about half of the mechanical strength of a magnetic high strength steel. Therefore, such a non-magnetic steel tie plate would need to have a significantly enlarged thickness compared to a tie plate made from magnetic high strength steel in order to obtain a certain degree of mechanical strength. Moreover, non-magnetic steels are typically more expensive than magnetic steels.

An increase in mechanical strength can generally be effectuated by work hardening (cold deformation) of non-magnetic austenitic steel. However, welding processes for attaching a tie plate made of such a material to the yoke clamping plates may mechanically weaken the material, at least locally.

Besides, carbon or glass fiber materials have sufficient tensile strength, but far too much elongation.

Therefore, there is a need for an improved transformer core assembly and an improved tie plate for use with a transformer core assembly.

This object is achieved by the independent claims. Dependent claims refer to preferred embodiments. Additional or alternative aspects of the present disclosure are addressed throughout this specification.

### SUMMARY

According to the present disclosure a transformer core assembly is provided that comprises a first yoke clamping plate for clamping a first yoke of a transformer core, and a second yoke clamping plate for clamping a second yoke of the transformer core. Further, the transformer core assembly comprises a plurality of stacked sheets forming a tie plate. The tie plate has a first end and a second end, wherein the first end is connected to the first yoke clamping plate and the second end is connected to the second yoke clamping plate.

Using stacked sheets for forming the tie plate significantly improves the quality of the tie plate. To build up a tie plate from a plurality of stacked sheets has proven to be advantageous both as regards mechanical properties of the resulting tie plate as well as regards production thereof.

Also, there is an increased availability of suited materials for manufacturing the tie plate. For example, there is a class of high manganese steel material having an adequate, high tensile strength which has proven particularly suitable. Moreover, this material can be welded with only a moderate reduction of the tensile strength. Besides, this material is comparatively cheap. However, a tie plate typically has a thickness between 12 and 15 mm and the high manganese steel material is hard to obtain in this thickness range in the relevant—comparatively small—amount typically used for transformer core assemblies. But a thinner gauge of this material, within a few Millimeters, is readily available on the market on coils. Thus, using stacked sheets of a corresponding gauge for forming the tie plate allows for providing a tie plate having adequate tensile strength at moderate cost, showing improved producibility.

Various embodiments may implement the following features:

The at least one of the stacked sheets may be of a non-magnetic composition. As outlined above, transformers may be exposed to non-alternating currents, causing a direct current bias magnetization which in turn causes saturation of the magnetic transformer core. Excess magnetic flux is thereby pushed into the magnetic tie plate where it causes excessive eddy current heating. This particularly reduces effectiveness of the transformer assembly and additionally requires increased cooling. Accordingly, using a non-magnetic composition for manufacturing at least one of the stacked sheets allows for an improvement of the effectiveness of the transformer core assembly.

The non-magnetic composition may be high manganese steel. The advantages of manganese steel have already been pointed out above.

Alternatively, the non-magnetic composition may be for example austenitic steel, particularly work-hardened austenitic steel. This kind of material is generally readily available, non-magnetic and showing an adequate tensile strength.

Tensile strength ranges and elongation ranges of several steel materials are described in “Advanced High Strength Steel Guidelines Version 5.0. World Auto Steel, May 2014”. Having in mind the function of a tie plate outlined above, a material for manufacturing a tie plate should have a high tensile strength and a low elongation. It has been found that the so called “third generation advanced high strength steel” (3rd GEN AHSS) described therein, namely steels having a tensile strength from about 800 MPa and more and up to 2000 MPa and more while having a low elongation, for example of about between about 5% and 39% may be used as material for manufacturing the sheets (both new and current generation). These steels are characterized by their high manganese content, for example 15 to 30%.

The sheets may have a thickness between 0.5 mm and 6 mm, for example between 1 mm and 4 mm.

The sheets may be connected to each other by a plurality of welding spots and/or a plurality of bolts. Welding spots as opposed to welding seams or the like have proven advantageous since disadvantageous effects of welding are thereby reduced to a minimum. Alternatively, or additionally, the sheets may be connected to each other for example by an adhesive. Such connection may be durable or just serve for relative fixation of the sheets to allow manufacture of holes through the sheets, as discussed below.

The tie plate may have a thickness between 10 mm and 20 mm, for example between 12 mm and 15 mm.

The tie plate may include a plurality of holes configured for positioning an attachment member, for example in form of a bolt or a pin, for attaching (i) the tie plate to the first and second yoke clamping plates and/or (ii) for attaching the plurality of sheets to one another for forming the tie plate. In this manner, it is not necessary to attach the tie plate to a clamping plate by a welding process which potentially weakens the material of the tie plate around the welding area, causing a reduction in tensile strength. Using a bolt or a pin having a smooth cylindrical surface for contacting the inner side of a corresponding hole is advantageous since this allows for a particularly good load transfer. Thus, for example bolts without a thread may be used as attachment members, or bolts having a thread only at an end region which is not designed or intended to be positioned within a hole.

The tie plate may be elongate, extending along a longitudinal axis, wherein the holes are formed in a series along the longitudinal axis of the tie plate. This allows for an improved matching of the shear strength of the attachment members and the tensile strength of the sheet material between the holes at a minimum overall width of the tie plate. Thereby, as much as possible of the tensile strength of the sheet material can be effectively used.

The plurality of holes may be laser beam cut, or water jet cut or machined. Machining the holes makes it possible to obtain holes having particularly smooth load bearing surfaces on its inner sides. This is particularly suited if un-threated bolts are used as attachment members. For example, the tie plate may be manufactured by connecting the sheets together, e.g., by welding spots, and subsequently machining the holes. Thus, the sheets are kept aligned adequately by the welding spots during the machining process. As an alternative to the welding connection, the sheets may be attached to one another for example by an adhesive.

The tie plate may comprise at least one slot. Typically, a tie plate is exposed to an electromagnetic fringe field from the windings. Especially in the region near the top and bottom winding ends this magnetic field has a strong component perpendicular to the core and to the tie plate which generates eddy currents flowing in a plane defined by the tie plate. These eddy currents cause losses which heat the tie plate. Therefore, providing the tie plate with at least one slot allows for reducing eddy current losses and avoiding or at least reducing local hot spots. Moreover, such a slot provides a path for an insulating fluid to cool the tie plate.

The tie plate may have a width between 20 mm and 80 mm, for example between 30 mm and 75 mm.

According to a second aspect of the present disclosure a tie plate for use with a transformer core assembly is provided, the tie plate comprising a plurality of stacked sheets.

The at least one of the stacked sheets may be of a non-magnetic composition.

The non-magnetic composition may be high manganese steel or austenitic steel.

The tie plate may include a plurality of holes configured for positioning an attachment member for attaching (i) the tie plate first and second yoke clamping plates and/or (ii) for attaching the plurality of sheets to one another for forming the tie plate.

In particular, the present disclosure comprises the following aspects:

1. A transformer core assembly, comprising:
a first yoke clamping plate for clamping a first yoke of a transformer core;
a second yoke clamping plate for clamping a second yoke of the transformer core; and
a plurality of stacked sheets forming a tie plate, the tie plate having a first end and a second end, wherein the first end is connected to the first yoke clamping plate and the second end is connected to the second yoke clamping plate.

2. The transformer core assembly of aspect 1, wherein the at least one of the stacked sheets is of a non-magnetic composition.

3. The transformer core assembly of aspect 1 or 2, wherein all of the stacked sheets are of a non-magnetic composition.

4. The transformer core assembly of aspect 2 or 3, wherein the non-magnetic composition is high manganese steel.

5. The transformer core assembly of aspect 4, wherein the high manganese steel has a manganese content between 20% by mass and 30% by mass.

6. The transformer core assembly of aspect 4 or 5, wherein the high manganese steel has a manganese content between 21% by mass and 28% by mass.

7. The transformer core assembly of any of aspects 4 to 6, wherein the high manganese steel has a manganese content between 22% by mass and 26% by mass.

8. The transformer core assembly of aspect 2 or 3, wherein the non-magnetic composition is austenitic steel.

9. The transformer core assembly of aspect 8, wherein the austenitic steel is work hardened.

10. The transformer core assembly of any of the preceding aspects, wherein at least one of the stacked sheets has a thickness between 0.5 mm and 6 mm.

11. The transformer core assembly of any of the preceding aspects, wherein at least one of the stacked sheets has a thickness between 1 mm and 4 mm.

12. The transformer core assembly of any of the preceding aspects, wherein all of the stacked sheets have a thickness between 0.5 mm and 6 mm.

13. The transformer core assembly of any of the preceding aspects, wherein all of the stacked sheets have a thickness between 1 mm and 4 mm.

14. The transformer core assembly of any of the preceding aspects, wherein all of the stacked sheets have the same thickness.

15. The transformer core assembly of any of the preceding aspects, wherein the tie plate has a thickness between 10 mm and 20 mm.

16. The transformer core assembly of any of the preceding aspects, wherein the tie plate has a thickness between 12 mm and 15 mm.

17. The transformer core assembly of any of the preceding aspects, wherein the stacked sheets are connected to each other by a plurality of welding spots.

18. The transformer core assembly of any of aspects 1 to 17, wherein the stacked sheets are connected to each other by a plurality of bolts.

19. The transformer core assembly of any of aspects 1 to 18, wherein the stacked sheets are connected to each other by an adhesive.

20. The transformer core assembly of any of the preceding aspects, wherein the tie plate includes a plurality of holes configured for positioning an attachment member and/or for positioning the tie plate relative to an attachment member for attaching (i) the tie plate to the first and second yoke clamping plates and/or (ii) for attaching the plurality of sheets to one another for forming the tie plate.

21. The transformer core assembly of aspect 20, wherein the attachment member is a bolt or a pin.

22. The transformer core assembly of aspect 20 or 21, wherein the tie plate is elongate, extending along a longitudinal axis, wherein the holes are formed in a series along and/or parallel to the longitudinal axis of the tie plate.

23. The transformer core assembly of aspect 22, wherein centers of the holes are located along a straight line parallel to or coinciding with the longitudinal axis of the tie plate.

24. The transformer core assembly of any of aspects 20 to 23, wherein the plurality of holes is laser beam cut, or water jet cut.

25. The transformer core assembly of any of aspects 20 to 23, wherein the plurality of holes is machined, or punched.

26. The transformer core assembly of any of the preceding aspects, wherein the tie plate has a length between 1 m and 5 m.

27. The transformer core assembly of any of the preceding aspects, wherein the tie plate has a width between 20 mm and 80 mm.

28. The transformer core assembly of any of the preceding aspects, wherein the tie plate has a width between 30 mm and 75 mm.

29. The transformer core assembly of any of the preceding aspects, wherein the tie plate comprises at least one slot.

30. The transformer core assembly of aspect 29, wherein the slot is longitudinal.

31. The transformer core assembly of any of the preceding aspects, wherein the tie plate comprises a plurality of slots.

32. The transformer core assembly of any of the preceding aspects, wherein the tie plate comprises one or more slots, at least one slot extending along the entire length or at least 80% of the entire length of the tie plate.

33. The transformer core assembly of any of the preceding aspects, comprising two or more tie plates.

34. The transformer core assembly of aspect 33, wherein the two or more tie plates are positioned adjacent to and parallel to each other.

35. The transformer core assembly of any of the preceding aspects, wherein the transformer core comprises a limb, wherein a winding is wound around the limb, and wherein the tie plate is positioned at least partly between the limb and the winding, and wherein the limb may be elongate, extending along a longitudinal axis, and wherein the tie plate may extend substantially parallel to said limb axis.

36. A tie plate for use with a transformer core assembly, the tie plate comprising a plurality of stacked sheets.

37. The tie plate of aspect 36, wherein the at least one of the stacked sheets is of a non-magnetic composition.

38. The tie plate of aspect 36 or 37, wherein all of the stacked sheets are of a non-magnetic composition.

39. The tie plate of any of the aspects 36 to 38, wherein the non-magnetic composition is high manganese steel.

40. The tie plate of aspect 39, wherein the high manganese steel has a manganese content between 20% by mass and 30% by mass.

41. The tie plate of aspect 39 or 40, wherein the high manganese steel has a manganese content between 21% by mass and 28% by mass.

42. The tie plate of any of aspects 39 to 41, wherein the high manganese steel has a manganese content between 22% by mass and 26% by mass.

43. The tie plate of any of aspects 36 to 38, wherein the non-magnetic composition is an austenitic steel.

44. The tie plate of aspect 43, wherein the austenitic steel is work hardened.

45. The tie plate of any of aspects 36 to 44, wherein at least one of the stacked sheets has a thickness between 0.5 mm and 6 mm.

46. The tie plate of any of aspects 36 to 45, wherein at least one of the stacked sheets has a thickness between 1 mm and 4 mm.

47. The tie plate of any of aspects 36 to 46, wherein all of the stacked sheets have a thickness between 0.5 mm and 6 mm.

48. The tie plate of any of aspects 36 to 47, wherein all of the stacked sheets have a thickness between 1 mm and 4 mm.

49. The tie plate of any of aspects 36 to 48, wherein all of the stacked sheets have the same thickness.

50. The tie plate of any of aspects 36 to 49, wherein the tie plate has a thickness between 10 mm and 20 mm.

51. The tie plate of any of aspects 36 to 50, wherein the tie plate has a thickness between 12 mm and 15 mm.

52. The tie plate of any of aspects 36 to 51, wherein the stacked sheets are connected to each other by a plurality of welding spots.

53. The tie plate of any of aspects 36 to 52, wherein the stacked sheets are connected to each other by a plurality of bolts.

54. The tie plate of any of aspects 36 to 53, wherein the stacked sheets are connected to each other by an adhesive.

55. The tie plate of any of the preceding aspects, wherein the tie plate includes a plurality of holes configured for positioning an attachment member for attaching (i) the tie plate to the first and second yoke clamping plates and/or (ii) for attaching the plurality of sheets to one another for forming the tie plate.

56. The tie plate of aspect 55, wherein the attachment member is a bolt or a pin.

57. The tie plate of aspect 55 or 56, wherein the tie plate is elongate, extending along a longitudinal axis, wherein the holes are formed in a series along the longitudinal axis of the tie plate.

58. The tie plate of aspect 57, wherein centers of the holes are located along a straight line parallel to or coinciding with the longitudinal axis of the tie plate.

59. The tie plate of any of aspects 55 to 58, wherein the plurality of holes is laser beam cut, or water jet cut.

60. The tie plate of any of aspects 55 to 58, wherein the plurality of holes is machined, or punched.

61. The tie plate of any of aspects 36 to 60, wherein the tie plate has a length between 1 m and 5 m.

62. The tie plate of any of aspects 36 to 61, wherein the tie plate has a width between 20 mm and 80 mm.

63. The tie plate of any of aspects 36 to 62, wherein the tie plate has a width between 30 mm and 75 mm.

64. The tie plate of any of aspects 36 to 63, wherein the tie plate comprises at least one slot.

65. The tie plate of aspect 64, wherein the slot is longitudinal.

66. The tie plate of aspect 36 or 65, wherein the tie plate comprises a plurality of slots.

### BRIEF DESCRIPTION OF THE DRAWINGS

The subject-matter of the disclosure will be explained in more detail with reference to preferred exemplary embodiments which are illustrated in the attached drawings, in which:

FIG. 1 is a schematic side view of a transformer core assembly according to the present disclosure.

FIG. 2 is a cross section along the line II-II indicated in FIG. 1.

FIG. 3 is a schematic perspective view of a tie plate according to the present disclosure.

FIG. 4a is a schematic plan view of a tie plate according to the present disclosure.

FIG. 4b is a schematic plan view of three tie plates positioned parallel to each other.

### DETAILED DESCRIPTION

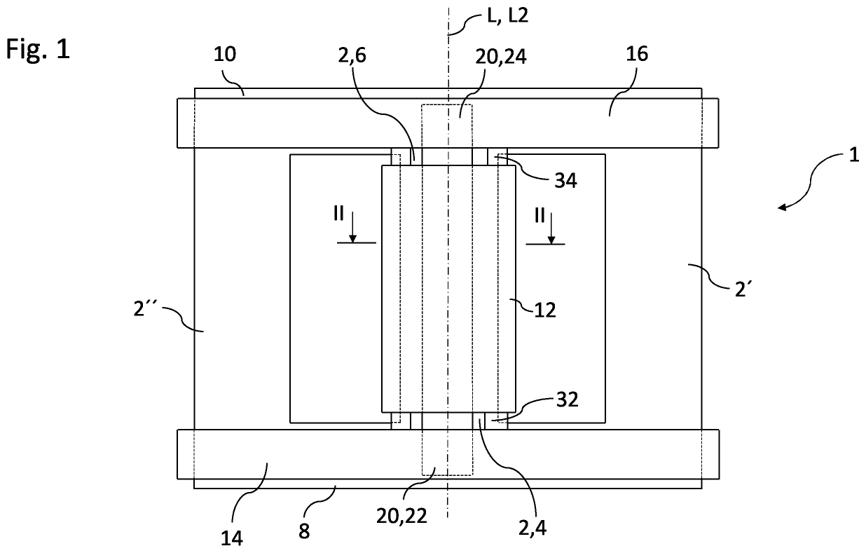

FIG. 1 a is a schematic side view of a transformer core assembly according to the present disclosure. Unless otherwise indicated, the transformer core assembly may be designed as described above in the background section.

The transformer core assembly comprises a transformer core 1 having a limb 2, extending along a longitudinal axis L, a first or bottom yoke 8 and a second or top yoke 10. The core 1 may further have at least one more limb 2′, 2″. The limb 2 may be oriented vertically.

The core 1 may be composed by a plurality of laminated core sheets as known as such in the art. The transformer core assembly further comprises two first yoke clamping plates 14 for clamping the core sheets within a section of the core 1 forming the first yoke 8, from two opposite sides, and two second yoke clamping plates 16 for clamping the core sheets within a section of the core 1 forming the second yoke 10.

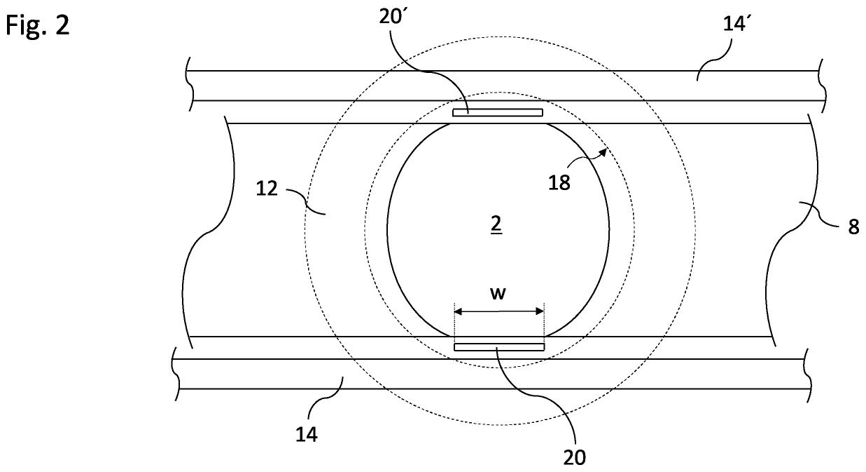

FIG. 2 shows a schematic cross-section through the limb 2. The parts are illustrated in an exploded manner, i.e., distances between adjacent parts are depicted which do not exist or which are exaggerated in order to improve visibility.

As can be seen in FIG. 2, the first yoke clamping plates 14, 14′ are arranged at two opposite sides of the first yoke 8. The first yoke clamping plates 14, 14′ are positioned such that they compress the first yoke 8. The second yoke clamping plates 16 are designed and arranged correspondingly.

As can be seen, e.g., in FIGS. 1 and 2, the transformer core assembly further comprises an elongate tie plate 20, extending along a longitudinal axis L2. The tie plate 20 has a first end 22 and a second end 24. The first end 22 is fixedly connected to a first one of the first yoke clamping plates 14, 14′. The second end 24 is analogously connected to a first one of the second yoke clamping plates 16.

Further, a winding 12 is wound around the limb 2. The tie plate 20 is positioned next to and parallel to the limb 2. The tie plate 20 may be positioned at least partly between the limb 2 and the winding 12. The tie plate 20 may extend substantially parallel to the limb axis L. The tie plate 20 may contact the limb 2. Alternatively, a thin electrically insulating sheet (not shown in FIG. 2) may be disposed between the tie plate 20 and the limb 2. The electrically insulating sheet may have a thickness of between 1 and 20 mm, for example between 1 mm and 10 mm.

The tie plate 20 is positioned at least partly between the limb 2 and an inner side 18 of the winding 12. The tie plate 20 may protrude with its first end 22 and its second end 24 from the winding 12. Further windings (not shown in FIGS. 1 and 2) may be correspondingly wound around each of the at least one more limb 2′, 2″.

A further tie plate 20′ may be provided next to the limb 2, attached to a second one of the first yoke clamping plates and to a second one to the second yoke clamping plates analogously.

The windings have to be maintained securely compressed axially for the life of the transformer. To this end, press rings 32, 34 are mounted at top and bottom of the winding block. These press rings 32, 34 are resting against the bottom and top yoke clamping plates 14, 16.

In the transformer core assembly, when operated as part of a transformer, a large electromagnetic force may be produced in the windings during an external fault in an electric network to which the transformer is connectable. Such a force may typically act in an axial direction of the limb 2. The tie plate 20 is designed and arranged to take such a force. Particularly, the tie plate 20 may be designed to have the functionality outlined above in the background section.

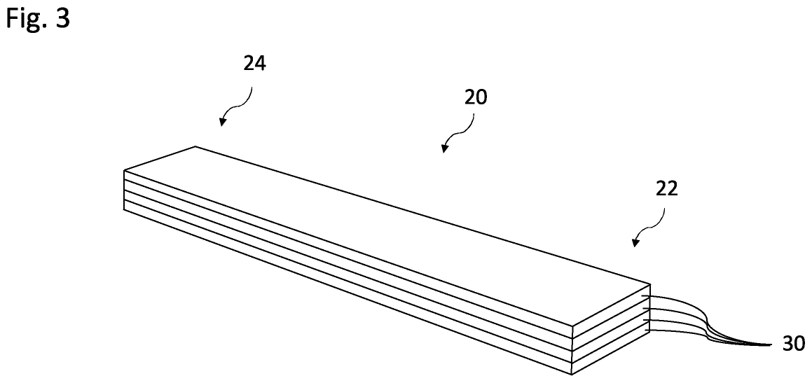

The tie plate 20 is formed by a plurality of stacked sheets 30, as schematically illustrated in FIG. 3. The stacked sheets 30 are of a non-magnetic composition, for example in the form of a high manganese steel material. The high manganese steel may have a manganese content between 20% by mass and 30% by mass, for example between 21% by mass and 28% by mass, or for example between 22% by mass and 26% by mass.

The non-magnetic composition alternatively may be austenitic steel. The austenitic steel may be work hardened.

The thickness of at least one of the sheets 30 or all of the sheets 30 may be within a few Millimeters, e.g., between 0.5 mm and 6 mm or between 1 mm and 4 mm. All the stacked sheets 30 may have the same thickness. The overall thickness of the tie plate 20 may be between 10 mm and 20 mm, for example between 12 mm and 15 mm.

The stacked sheets 30 may be connected to each other by a plurality of welding spots. The stacked sheets 30 may be connected to each other by a plurality of bolts. The stacked sheets 30 may be connected to each other by an adhesive.

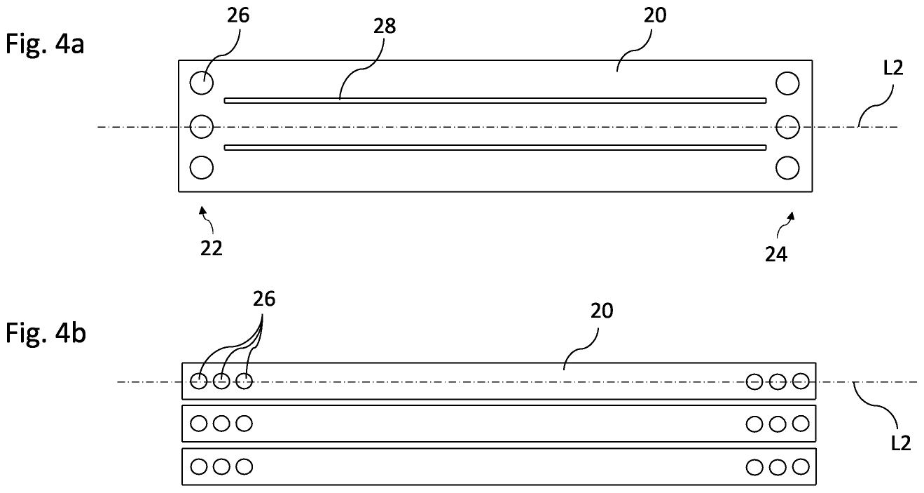

As sketched in FIG. 4a, the tie plate 20 may have a plurality of holes 26 configured for positioning an attachment member (not shown in the Figures). The plurality of holes 26 may be configured for positioning an attachment member and/or for positioning the tie plate 20 relative to an attachment member for attaching (i) the tie plate 20 to the first yoke clamping plate 14 and the second yoke clamping plate 16 and/or for attaching the plurality of sheets 30 to one another for forming the tie plate 20. The attachment member may be for example a bolt or a pin.

The tie plate 20 may be manufactured by welding the sheets 30 together and by subsequently machining the holes 26. Machining the holes 26 allows for producing the holes 26 such that they show smooth inner surfaces.

Further, as sketched in FIG. 4a, the tie plate 20 may comprise at least one slot 28, particularly a longitudinal slot 28, for example extending parallel to the longitudinal axis L2 of the tie plate 20. The tie plate 20 may comprise one or more slots 28, at least one slot 28 extending along the entire length or at least 80% of the entire length of the tie plate 20.

As illustrated in FIG. 4b, the tie plate 20 may have a plurality of holes 26 formed in a series along the longitudinal axis L2 of the tie plate 20, and/or parallel to the longitudinal axis L2 of the tie plate 20, for example such that centers of the holes 26 are located along a straight line parallel to or coinciding with the longitudinal axis L2. Such a series of holes 26 is advantageous vis-à-vis the design of FIG. 4a, since shear strength of the bolts can be better matched.

The holes 26 may be laser beam cut, water jet cut, machined or punched.

Further, as sketched in FIG. 4b, several tie plates can be used positioned adjacent to and parallel to one another side by side to mechanically support the limb 2.

The width w of the tie plate 20 may be between 20 mm and 80 mm, for example between 30 mm and 75 mm, its length between 1 m and 5 m.

While the present disclosure has been described in detail in the drawings and forgoing description, such description is to be considered illustrative or exemplary and not restrictive. Variations to the disclosed embodiments can be understood and effected by those skilled in the art and practicing the claimed subject-matter, from a study of the drawings, the disclosure, and the appended claims. In the claims, the word “comprising” does not exclude other elements, and the indefinite article “a” or “an” does not exclude a plurality. The mere fact that certain elements or steps are recited in distinct claims does not indicate that a combination of these elements or steps cannot be used to advantage, specifically, in addition to the actual claim dependency, any further meaningful claim combination shall be considered disclosed.

1. A transformer core assembly, comprising:
a first yoke clamping plate for clamping a first yoke of a transformer core;
a second yoke clamping plate for clamping a second yoke of the transformer core; and
a plurality of stacked sheets forming a tie plate, the tie plate having a first end and a second end, wherein the first end is connected to the first yoke clamping plate and the second end is connected to the second yoke clamping plate.

2. The transformer core assembly of claim 1, wherein the at least one of the stacked sheets is of a non-magnetic composition.

3. The transformer core assembly of claim 2, wherein the non-magnetic composition is high manganese steel or austenitic steel.

4. The transformer core assembly of claim 1, wherein the plurality of stacked sheets have a thickness between 0.5 mm and 6 mm.

5. The transformer core assembly of claim 1, wherein the tie plate has a thickness between 10 mm and 20 mm.

6. The transformer core assembly of claim 1, wherein the plurality of stacked sheets are connected to each other by a plurality of welding spots and/or a plurality of bolts.

7. The transformer core assembly of claim 1, wherein the tie plate includes a plurality of holes configured for positioning an attachment member, for attaching (i) the tie plate to the first and second yoke clamping plates and/or (ii) for attaching the plurality of sheets to one another for forming the tie plate.

8. The transformer core assembly of claim 7, wherein the tie plate is elongate, extending along a longitudinal axis, wherein the holes are formed in a series along the longitudinal axis of the tie plate.

9. The transformer core assembly of claim 7,
wherein the plurality of holes is laser beam cut, or water jet cut, or machined.

10. The transformer core assembly of claim 1, wherein the tie plate comprises at least one slot.

11. The transformer core assembly of claim 1, wherein the tie plate has a width between 20 mm and 80 mm, and/or a length between 1 m and 5 m.

12. A tie plate for use with a transformer core assembly, the tie plate comprising a plurality of stacked sheets.

13. The tie plate of claim 12, wherein the at least one of the plurality of stacked sheets is of a non-magnetic composition.

14. The tie plate of claim 13, wherein the non-magnetic composition is high manganese steel or austenitic steel.

15. The tie plate of claim 12, wherein the tie plate includes a plurality of holes configured for positioning an attachment member for attaching (i) the tie plate to a first yoke clamping plate and a second yoke clamping plate and/or (ii) for attaching the plurality of sheets to one another for forming the tie plate.

16. The tie plate of claim 13, wherein the high manganese steel has a manganese content between 20% by mass and 30% by mass.

17. The tie plate of claim 13, wherein the high manganese steel has a manganese content between 21% by mass and 28% by mass.

18. The tie plate of claim 12 wherein the tie plate is elongate, extending along a longitudinal axis, wherein holes are formed in a series along the longitudinal axis of the tie plate.

19. The tie plate of claim 12, wherein the tie plate has a first end and a second end, wherein the first end is connected to a first yoke clamping plate of the transformer core assembly and the second end is connected to a second yoke clamping plate of the transformer core assembly.

20. The tie plate of claim 12, wherein the transformer core assembly comprises a limb, wherein a winding is wound around the limb, and wherein the tie plate is positioned at least partly between the limb and the winding, and wherein the limb may be elongate, extending along a longitudinal axis, and wherein the tie plate may extend substantially parallel to said limb axis.
